(19) United States
(12) Patent Application Publication
(10) Pub. No.: US 2013/0008924 A1
(43) Pub. Date: Jan. 10, 2013

(54) FLUID DISPENSER

(75) Inventor: Alain Lafosse, Louversey (FR)

(73) Assignee: APTAR FRANCE SAS, Le Neubourg (FR)

(21) Appl. No.: 13/578,155

(22) PCT Filed: Feb. 8, 2011
(86) PCT No.: PCT/FR11/50254

§ 371 Date: Sep. 4, 2012

(30) Foreign Application Priority Data
Feb. 11, 2010 (FR) 1050960

(51) Int. Cl. G01F 11/00; B65D 83/76

(52) U.S. Cl. 222/256; 222/386

(57) ABSTRACT

A fluid dispenser comprising:
a fluid reservoir (1) including an opening (11); and
a dispenser head (2) including a fastener ring (33) for coming into engagement with the opening (11);
the ring (33) and the opening (11) forming leaktight final assembly means (12, 34), making it possible to fasten the dispenser head (2) in a final assembled position, in stable and leaktight manner in the opening (11) of the reservoir;
said dispenser being characterized in that the ring (33) and the opening (11) further form provisional pre-assembly means (13, 34) making it possible to fasten the dispenser head (2) in a provisional pre-assembled position, in provisional and non-leaktight manner in the opening of the reservoir.

The present invention relates to a fluid dispenser comprising: a reservoir and a dispenser head through which the fluid from the reservoir is dispensed. The reservoir includes an opening, and the dispenser head includes a fastener ring that comes into engagement with the opening. The ring and the opening form leaktight final assembly means that make it possible to fasten the dispenser head in a final assembled position, in stable and leaktight manner in the opening of the reservoir. Such fluid dispensers are frequently used in the fields of cosmetics, perfumery, and even pharmacy.

In the field of cosmetics, reservoirs are sometimes used having an opening that is particularly large, possibly presenting a diameter that is greater than 3 centimeters (cm) or 4 cm. By way of example, the reservoir may be in the form of a cylindrical pot inside which there is slidably mounted a follower piston that moves inside the pot as the fluid is extracted from the reservoir. The opening of the reservoir thus extends in alignment with the pot, and presents the same diameter as the reservoir. In combination with such a reservoir, a dispenser head is frequently used that is of large diameter, but of small height. This means that the dispenser head penetrates only a little into the opening of the reservoir. A known type of dispenser head presents a substantially-plane bottom face against which the follower piston comes into contact when the reservoir is empty. In summary, such a dispenser includes a reservoir having an opening that is large, and a dispenser head that penetrates a little into the reservoir.

During assembly of such a dispenser, initially the reservoir is filled with fluid. Then, the dispenser head is placed in the opening of the reservoir without performing the final assembly. There is not yet any sealing between the dispenser head and the reservoir. A following step that is optional, but increasingly common, consists in subjecting the dispenser to a vacuum so as to evacuate the air present in the reservoir. The following final step consists in assembling the dispenser head in permanent and leaktight manner on the reservoir.

In order to perform the various steps, the dispensers are conveyed through various stations by means of a conveyer. More precisely, the reservoir is placed on the conveyer that serves to convey it from one station to another, in which stations the various assembly steps are performed. However, given that the dispenser head is merely placed in the opening of the reservoir after the filling step, it sometimes happens that the dispenser head falls off the reservoir while it is being conveyed towards the next step of packaging under vacuum or of final assembly. The dispenser head may be caused to fall off by a sudden stoppage of the conveyer that is conveying the fluid-filled reservoir. The dispenser head falls off more easily when it penetrates very little into the reservoir, and when the reservoir opening is large. A single dispenser head that has fallen off its reservoir suffices to block the entire assembly line.

An object of the present invention is to remedy the above-mentioned drawback of the prior art by defining a dispenser having a dispenser head that does not risk being dislodged from its reservoir on the assembly line between the moment at which the head is placed on the reservoir and the moment at which the dispenser head is assembled permanently on the reservoir. Another object of the present invention is to prevent the dispenser head from falling off, while conserving the possibility of subjecting the dispenser to packaging under vacuum. The present invention applies very particularly to the field of cosmetics with the above-mentioned type of dispenser, but it may also apply to other fields with different types of reservoir and dispenser head.

To achieve these objects, the present invention proposes that the ring and the opening further form provisional pre-assembly means making it possible to fasten the dispenser head in a provisional pre-assembled position, in provisional and non-leaktight manner in the opening of the reservoir. Advantageously, the assembly means are snap-fastener means. In a variant or in addition, the pre-assembly means may also be snap-fastener means. Thus, the dispenser head is secured to the reservoir in the provisional pre-assembled position, thereby avoiding any risk of the dispenser head being lost or falling off. In addition, given that the provisional pre-assembly is not leaktight, it is possible to subject the dispenser, and more particularly the content of the reservoir, to a vacuum so as to evacuate the air that it contains. Then, the dispenser head is assembled in permanent and leaktight manner on the reservoir. In other words, firstly the dispenser head is pre-snap-fastened in non-leaktight manner on the reservoir, then secondly the head is snap-fastened in permanent and in leaktight manner on the reservoir. Between the two snap-fastenings, the dispenser head is secured to the reservoir, but it is still possible to perform vacuum packaging.

In a practical embodiment, the assembly means comprise a first snap-fastener groove formed at the opening, and a first snap-fastener rib formed by the fastener ring, the first rib being snap-fastened in the first groove in the final assembled position.

Advantageously, the pre-assembly means comprise a second snap-fastener groove formed at the opening, and the first snap-fastener rib formed by the fastener ring, the first rib being snap-fastened in the second groove in the pre-assembled position.

Preferably, the opening defines a top annular edge, the second groove being situated closer to the annular edge than the first groove.

According to a particularly advantageous characteristic, the ring forms a second rib that becomes snap-fastened in leaktight manner in the second groove in the final assembled position. Thus, in its final assembled position, the dispenser head is snap-fastened twice in the opening of the reservoir, thereby increasing not only the stability of the head on the reservoir, but also the sealing between the ring and the opening.

According to another characteristic of the invention, the opening defines a top annular edge, the fastener ring forming a peripheral flange that comes to bear against the edge of the opening in the final assembled position.

In another aspect of the invention, the reservoir includes a follower piston that slides in leaktight manner inside a cylinder formed by the reservoir, the follower piston moving between the pre-assembled position and the final assembled position so as to avoid any increase in pressure inside the reservoir. This characteristic, that may be implemented independently of the provisional pre-assembly, makes it possible, in very simple manner, to prevent any increase in pressure inside the reservoir that would result from the leaktight stroke of the dispenser head inside the opening during assembly.

In an advantageous embodiment, the dispenser head presents a bottom face that is oriented towards the reservoir, the bottom face forming a top for closing the reservoir, the bottom face being substantially plane and projecting very little into the reservoir below the fastener ring. The present invention finds a particular advantage when the dispenser head presents a plane bottom face that penetrates only a little into the reservoir. As mentioned above, this is the situation with cosmetic pumps that are assembled on reservoirs that present an opening of large section.

In another aspect of the invention, the reservoir includes a slide cylinder and a follower piston that slides in the cylinder, the opening extending in alignment with the cylinder. This means that the opening of the reservoir presents a diameter that is substantially equal to the diameter of the reservoir in which the follower piston slides.

The idea of the invention resides in pre-assembling, in provisional and non-leaktight manner, a dispenser head on a reservoir ready for leaktight final assembly. This provisional pre-assembly may be performed by snap-fastening, or even merely by non-leaktight clamping.

The invention is described more fully below with reference to the accompanying drawings, which show an embodiment of the invention by way of non-limiting example.

In the figures:

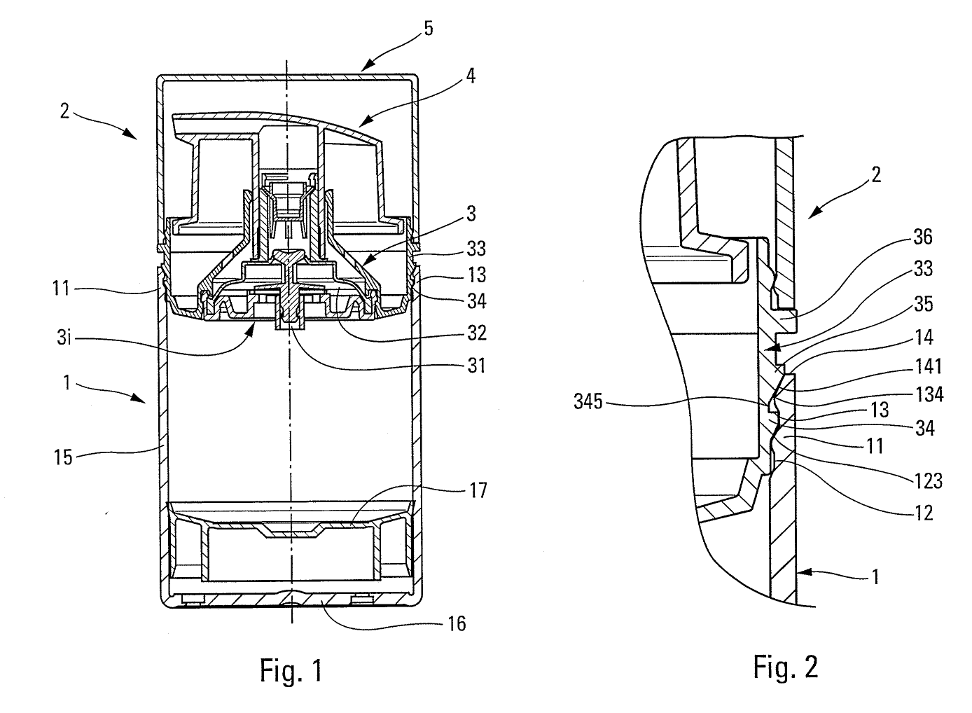

FIG. 1 is a vertical section view through a fluid dispenser of the invention in its provisional pre-assembled position;

FIG. 2 is a greatly enlarged view of a detail of FIG. 1 showing the engagement of the head in the reservoir in its provisional pre-assembled position;

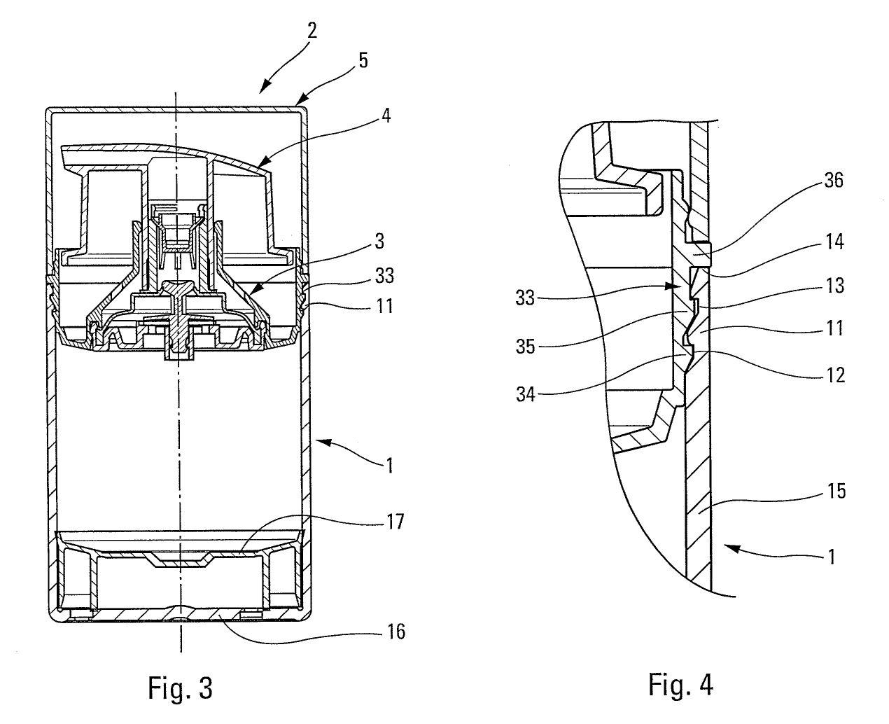

FIG. 3 is a view similar to the view in FIG. 1 in the final assembled position; and

FIG. 4 is a view similar to the view in FIG. 2 in the final assembled position.

The fluid dispenser shown in FIGS. 1 to 4 is a dispenser for dispensing a cosmetic of pasty or creamy consistency. Nevertheless, the dispenser may be used for dispensing pharmaceuticals, such as pomades. The dispenser comprises two main sub-assemblies, namely a fluid reservoir 1 and a dispenser head 2.

The fluid reservoir 1 includes a substantially-cylindrical pot comprising a cylindrical slide cylinder 15 that is closed at its bottom end by a bottom wall 16. The opposite end of the cylinder 15 defines an opening 11 having a section that is substantially or completely identical to the section of the cylinder 15. Consequently, the reservoir 1 defines an opening 11 of large section, since it extends exactly in alignment with the cylinder 15. The reservoir 1 also includes a follower-piston 17 that is mounted to slide in leaktight manner inside the cylinder 15. Initially, the follower piston 17 is arranged in the proximity of the bottom wall 16, but it should be observed, in FIG. 1, that the follower piston 17 is not in contact with the bottom wall 16, but, on the contrary, is separated from the bottom wall by a short distance. The pot and the follower piston may be made by injection-molding plastics material. It is also possible to envisage making the pot out of glass or even out of metal.

In the invention, as shown in FIGS. 2 and 4, the opening 11 includes an outer wall and an inner wall that are interconnected at the top end of the reservoir 1 via an annular edge 14. The inner wall of the opening 11 defines, from bottom to top, a first snap-fastener groove 12, a second snap-fastener groove 13, and a frustoconical inlet bevel 141 that joins the top edge 14. The two snap-fastener grooves 12 and 13 are separated by a first bead 123. The second snap-fastener groove 13 is separated from the frustoconical bevel 141 by a second bead 134. In the figures, it should be observed that the inside diameter of the first snap-fastener groove 12 is less than the inside diameter of the second snap-fastener groove 13.

The dispenser head 2 includes a pump 3 that defines an inlet 31 that communicates with the reservoir 1. The pump 3 defines a pump chamber 32 of volume that varies, making it possible to put the fluid under pressure. The pump also includes a fastener ring 33 that comes into engagement with the opening 11 of the reservoir. The dispenser head also includes a pusher 4 that is associated with the pump 3 so as to actuate it. Optionally, the dispenser head includes a protective cap 5 that is mounted in removable manner on the fastener ring 33 and that masks the pusher 4. This is an entirely conventional design for a dispenser head in the fields of cosmetics, perfumery, and even pharmacy.

With reference once again to FIGS. 2 and 4, it can be seen that the fastener ring 33 includes a first snap-fastener rib 34 and a second snap-fastener rib 35 that are separated by a groove 345. The maximum outside diameter of the first snap-fastener rib 34 is less than the maximum outside diameter of the second snap-fastener rib 35. The fastener ring 33 also forms a peripheral flange 36 that projects radially outwards, and that is for coming to bear against the annular edge 14 of the opening 11.

FIG. 2 shows the fastener ring 33 in its provisional pre-assembly position in the opening 11 of the reservoir 1. In this position, The peripheral flange 36 does not bear against the annular edge 14. The second snap-fastener rib 35 is in contact with the inlet bevel 141, while the first snap-fastener rib 34 is housed in the second snap-fastener groove 13. The first snap-fastener groove 12 is empty. In this provisional pre-assembly position, there is no sealing between the ring 33 and the opening 11. Consequently, the content of the reservoir 1 is still in communication with the outside. In this provisional pre-assembled position, it is possible to subject the dispenser to a vacuum so as to evacuate the air present inside the reservoir. It is not necessary for the dispenser head to be completely stable on the reservoir 1 in the provisional pre-assembled position. It suffices for the head to be secured to the reservoir, even if it still presents a certain degree of freedom. In other words, the first snap-fastener rib 34 is received in loose manner in the second snap-fastener groove 13, and the second snap-fastener rib 35 bears in non-clamping manner against the inlet bevel 141. However, the first snap-fastener rib 34 is held captive by the second snap-fastener groove 13. By way of example, provision may be made for the maximum outside diameter of the first snap-fastener rib 34 to be less than the maximum inside diameter of the second snap-fastener groove 13.

In this provisional pre-assembled position, the dispenser may thus be conveyed over the conveyer up to the leaktight-final-assembly station, and optionally to a vacuum packaging station. There is no risk of the head being dislodged from the reservoir because the first snap-fastener rib 34 is snap-fastened in the second snap-fastener groove 13, which co-operate with each other to constitute provisional pre-assembly means that make it possible to fasten the dispenser head in provisional and non-leaktight manner in the opening of the reservoir.

FIG. 4 shows the fastener ring 33 in its leaktight final assembled position inside the opening 11 of the reservoir. The peripheral flange 36 now bears against the annular edge 14 of the opening 11. The first snap-fastener rib 34 is housed in the first snap-fastener groove 12, while the second snap-fastener rib 35 is housed in the second snap-fastener groove 13. The fastener ring 33 is thus in leaktight contact with the opening 11 over its entire periphery, in such a manner as to isolate the inside of the reservoir from the outside. Sealing may be provided at any point of contact between the ring 33 and the opening 11. By way of example, sealing may be provided at the rib 34 in contact with the groove 12. Sealing may also be provided at the rib 35 in contact with the groove 13. Leaktight contact may also be provided between the flange 36 and the edge 14. Preferably, two seals are provided by the two ribs 34 and 35 making contact with the two grooves 12 and 13 respectively. Thus, complete sealing of the dispenser and increased stability are guaranteed. Two distinct snap-fastenings over the height of the opening 11 guarantee complete stability, and advantageously prevent the dispenser from being removed.

It should also be observed in FIGS. 1 and 3 that the dispenser head presents a bottom face 3i that is practically plane and that penetrates very little into the reservoir. As mentioned above, this is a particular dispenser-head configuration that is often used in the field of cosmetics. With this type of configuration, the head penetrates very little into the reservoir, and would normally tend to fall off the reservoir on the assembly line between the moment at which the head is merely placed on the reservoir and the moment at which the head is assembled in permanent manner on the reservoir. By means of the present invention, any risk of the dispenser head falling off while in its provisional pre-assembled position is eliminated, while conserving the possibility of performing packaging under vacuum.

1. A fluid dispenser comprising:
a fluid reservoir including an opening defining an inner wall; and
a dispenser head through which the fluid from the reservoir is dispensed, the head including a fastener ring for coming into engagement with the inner wall of the opening;
the ring and the opening forming leaktight final assembly means, making it possible to fasten the dispenser head in a final assembled position, in stable and leaktight manner in the opening of the reservoir;
said dispenser being characterized in that the ring and the opening further form provisional pre-assembly means making it possible to fasten the dispenser head in a provisional pre-assembled position, in provisional and non-leaktight manner in the opening of the reservoir.

2. A dispenser according to claim 1, wherein the assembly means are snap-fastener means.

3. A dispenser according to claim 1, wherein the pre-assembly means are snap-fastener means.

4. A dispenser according to any preceding claim, wherein the assembly means comprise a first snap-fastener groove formed at the opening, and a first snap-fastener rib formed by the fastener ring, the first rib being snap-fastened in the first groove in the final assembled position.

5. A dispenser according to claim 4, wherein the pre-assembly means comprise a second snap-fastener groove formed at the opening, and a first snap-fastener rib formed by the fastener ring, the first rib being snap-fastened in the second groove in the pre-assembled position.

6. A dispenser according to claim 5, wherein the opening defines a top annular edge, the second groove being situated closer to the annular edge than the first groove.

7. A dispenser according to claim 5, wherein the ring forms a second rib that becomes snap-fastened in leaktight manner in the second groove in the final assembled position.

8. A dispenser according to claim 1, wherein the opening defines a top annular edge, the fastener ring forming a peripheral flange that comes to bear against the edge of the opening in the final assembled position.

9. A dispenser according to claim 1, wherein the reservoir includes a follower piston that slides in leaktight manner inside a cylinder formed by the reservoir, the follower piston moving between the pre-assembled position and the final assembled position so as to avoid any increase in pressure inside the reservoir.

10. A dispenser according to claim 1, wherein the dispenser head presents a bottom face that is oriented towards the reservoir, the bottom face forming a top for closing the reservoir, the bottom face being substantially plane and projecting very little into the reservoir below the fastener ring.

11. A dispenser according to claim 1, wherein the reservoir includes a slide cylinder and a follower piston that slides in the cylinder, the opening extending in alignment with the cylinder.
